(19) United States
(12) Patent Application Publication
(10) Pub. No.: US 2026/0143059 A1
(43) Pub. Date: May 21, 2026

(54) Controlling a Service on Board a Vehicle

(71) Applicant: Bayerische Motoren Werke Aktiengesellschaft, Muenchen (DE)

(72) Inventors: Etienne ILIFFE-MOON, Menlo Park, CA (US); Iris KOSER, San Carlos, CA (US)

(21) Appl. No.: 18/704,218

(22) PCT Filed: Sep. 20, 2022
(86) PCT No.: PCT/EP2022/076040

§ 371 Date: Apr. 24, 2024

(30) Foreign Application Priority Data
Oct. 29, 2021 (DE) 10 2021 128 351.5

(51) Int. Cl. H04M 1/72409; B60K 35/22; B60K 35/81; H04W 4/029; H04W 4/48

(52) U.S. Cl. CPC H04M 1/724098; B60K 35/22; B60K 35/81; H04W 4/029; H04W 4/48

(57) ABSTRACT

A method for controlling a service on board a vehicle includes steps of detecting a mobile device on board the vehicle, providing a graphical representation of the mobile device, and detecting an assignment of the detected mobile device to a function of the vehicle with respect to the graphical representation.

### BACKGROUND AND SUMMARY

The present invention relates to controlling a service on board a vehicle. In particular, the invention relates to connecting a mobile device to a vehicle.

A vehicle is configured to be connected to a mobile device, so that, for example, an audio output of the mobile device can take place via an entertainment system of the vehicle. The vehicle can also be used to provide information to the mobile device, for example, in that a mobile wireless connection of the vehicle is used.

A communication connection between the mobile device and the vehicle is typically established wirelessly. A technology such as Bluetooth, Bluetooth-LE, or Wi-Fi can be used here, for example. Establishing a communication connection can be automated, but a multistep process is typically required for the initial configuration of the connection, which is often not completely understood by a user. For example, in the case of Bluetooth a recognition phase (“discovery”) can be provided, in which one device can recognize another. A device which wishes to be recognized has to make itself visible for this purpose. A second device to be coupled then has to be selected on a first device. For this purpose, the second device can provide a brief identification in the form of a character string. A coupling (“pairing”) with the selected device can then be created. For this purpose, it can be necessary to carry out an authentication. In a last phase, a connection can be established (“connecting”).

A user who is located on board a vehicle previously unknown to him wishes to network his mobile device with the vehicle for communication. The described sequence of steps can be perceived as annoying by him. In addition, it can be difficult to conclude an actual mobile device from a displayed character string. In a reverse application, for example, a person who wishes to establish a communication connection between the vehicle and one of multiple mobile devices located on board can have difficulties in identifying the individual mobile devices on the basis of their identifiers. This task can be made even more complex if not only a mobile device, but a service running on the mobile device is to be selected. The probability of incorrect operation can be high in this case.

One object underlying the present invention is therefore to specify an improved technology for controlling a service on board a vehicle. The invention achieves this object by means of the subjects of the independent claims. Dependent claims disclose preferred embodiments.

According to a first aspect of the present invention, a method for controlling a service on board a vehicle comprises steps of detecting a mobile device on board the vehicle; providing a graphic representation of the mobile device; and detecting an assignment of the detected mobile device to a function of the vehicle with respect to the graphic representation.

According to the invention, the selection of the matching terminal and the identification of a service running thereon can take place in an improved manner with respect to a graphic representation, which can be more easily comprehensible by a user. The user can provide an input on the basis of the graphic representation in order to express an assignment desired by him. The desired assignment can then be implemented. Possible further required steps for establishing a communication connection between the vehicle and the mobile device can take place automatically in an improved manner. Overall, it can be made significantly easier for a user to network a mobile device with the vehicle or vice versa and to control a service of one device on the respective other one.

In one embodiment, an identification of the mobile device is determined and the graphic representation comprises a reference to the identification. The identification can comprise a character string here, using which the mobile device identifies itself. In addition, information such as a producer, a model, an embodiment, or a name settable by a user can be displayed. The graphic representation can comprise the reference in text form or preferably in graphic form. Thus, for example, different graphic symbols can be used for different models of smartphones or tablet computers. Optionally, for example, a logo of a producer can be graphically displayed.

In a further preferred embodiment, a position of the mobile device on board the vehicle is determined, wherein the graphic representation comprises a reference to the determined position. It is preferred in particular that the position of the mobile device with respect to the vehicle is graphically represented.

A graphic representation of a mobile device can be placed realistically here. In other words, a position of the representation of the mobile device with respect to the representation of the vehicle can correspond to a position of the mobile device with respect to the vehicle.

The representation of the vehicle does not have to be realistic, but can also be embodied as technical, schematic, abstract, or artistic. At least some details of the vehicle, in particular if they are striking or relevant, can be found on the representation. In all cases, it is preferred for the finding of a mobile device on board the vehicle to be possible on the basis of the displayed representation of the mobile device with respect to the representation of the vehicle.

In a further embodiment, a user assigned to the mobile device can be determined, wherein the representation comprises a reference to the determined user. The user can be identified, for example, textually on the basis of his name or a pseudonym selected by him. The user can also determine an image, a symbol image, or an avatar which can be graphically displayed as a reference to the user.

In a further preferred embodiment, the assignment comprises establishing a wireless pairing and/or connection of the mobile device to the vehicle.

In still another embodiment, the assignment comprises determining access rights. In other words, it can also be defined by the assignment to which resources a service has access. Exemplary resources comprise a data connection, an audio input, an audio output, an optical input, an optical output, or a function of a system or a component on board the vehicle.

The assignment can therefore define a cooperation of the mobile device with the vehicle. If a specific service is offered by multiple devices, it can thus be decided which device is to handle the service. An assignment between vehicle functions and services can be controllable in an arbitrarily finely granular manner.

According to a further aspect of the present invention, a device for controlling a service on board a vehicle comprises a sensor for detecting a mobile device on board the vehicle; a graphic output unit for providing a graphic representation of the detected mobile device; an input unit for detecting an assignment of the mobile device to a function of the vehicle with respect to the graphic representation; and a control device for controlling the function in order to provide the service.

The control device can comprise a programmable microcomputer or microcontroller and can be configured to partially or completely carry out a method described herein. For this purpose, the method can be provided in the form of a computer program product having program code means. The computer program product can also be stored on a computer-readable data carrier. Features or advantages of the method can be transferred to the device or vice versa.

In a further preferred embodiment, the sensor comprises an interior camera. The interior camera is preferably configured to optically scan an interior in which persons on board the vehicle can be located. The interior camera can also be used to establish a connection between the mobile device and the vehicle. For this purpose, a predetermined output can be generated on the mobile device, for example, a barcode or a QR code. The displayed information can previously have been generated by the mobile device or the vehicle in the scope of an authentication. The displayed graphic can be presented to the interior camera in order to complete the authentication.

In a similar manner, an output which is represented in text or graphics on the mobile device can be acquired by the interior camera. A decisive step of a multistep authentication can thus be simplified.

In a further embodiment, the sensor is configured to recognize a mobile device or an assigned user. For example, a mobile device can be recognized by means of NFC. The user can be identified by means of the interior camera or another sensor. For this purpose, the user can carry with him a device scannable by the sensor, for example, a secure number generator, which is known under the name key fob. A wireless communication can preferably take place here.

In a further embodiment, the mobile device can be used to describe a gesture. The gesture can be specified on a display of the mobile device in the scope of an authentication and can be implemented by a user. The gesture can be determined by means of an acceleration sensor of the mobile device and can be transmitted to the vehicle. The gesture can also be recognized, for example, by means of one or more interior cameras of the vehicle. In still a further embodiment, a hand gesture of the user within the vehicle with respect to the mobile device can be recognized. A camera of the mobile device or the vehicle can be used for this purpose.

The sensor can comprise a communication unit for wireless communication with the mobile device. The wireless communication can in particular take place with an identification unit, which can be comprised by the mobile device. The identification unit can comprise, for example, an NFC label. Alternatively, for the wireless communication, and other technologies such as Wi-Fi or Bluetooth can also be used. A mobile device of a user invisible to an interior camera of the vehicle can thus also be detected. The mobile device can, for example, be carried by the user on the body, it can be located in a glove compartment or another shelf of the vehicle, or can be located in the luggage, for example, in a baggage compartment of the vehicle.

The output unit, on which the graphic representation of the mobile device is provided, can comprise a display screen on board the vehicle. The vehicle can comprise multiple display screens, of which one or more can be usable as the output unit. A usable display screen can be designed in particular as a touchscreen. The output unit can also comprise a less conventional display unit such as a head-up display, a projector, or AR/VR glasses, however.

According to still another aspect of the present invention, a vehicle comprises a device described herein, a wireless communication unit for communication with a mobile device, and at least one functional component for providing or using a service. The service can be provided in particular using a communication channel which is maintained by the communication unit.

In a particularly preferred embodiment, the functional component comprises an optical, acoustic, or haptic input and/or output device for a person on board the vehicle. The mobile device can thus be operated in a mode which is known as the projected mode. One or more input and/or output devices on board the vehicle can be used here to interact with a user in the scope of a provided service. The service itself can be provided by the mobile device or a processing unit comprised thereby.

The invention will now be described in more detail with reference to the appended drawings, in which:

### BRIEF DESCRIPTION OF THE DRAWINGS

FIG. 1 illustrates the system;

FIG. 2 illustrates an exemplary graphic representation; and

FIG. 3 illustrates a flow chart of a method.

### DETAILED DESCRIPTION OF THE DRAWINGS

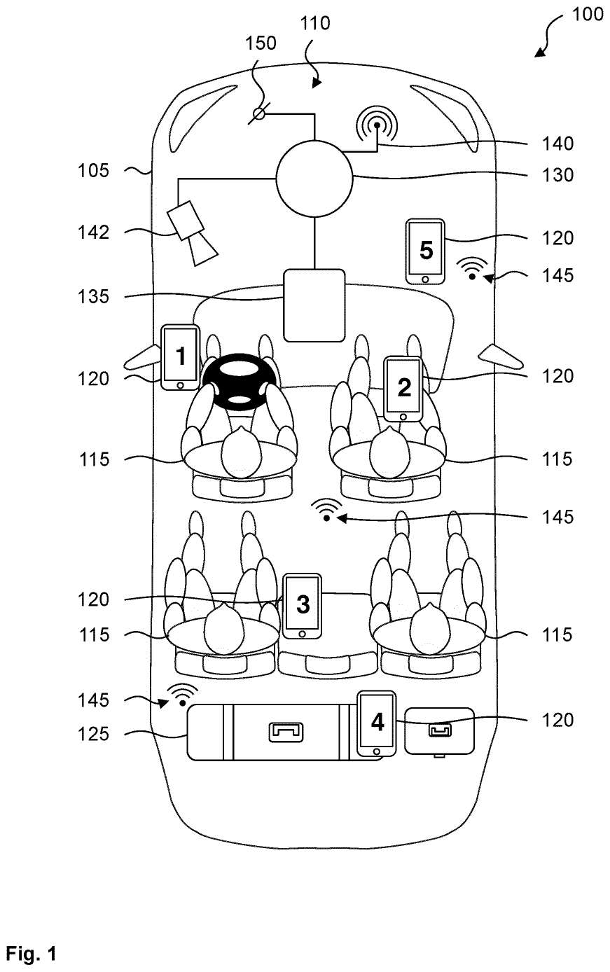

FIG. 1 shows a system 100, which comprises a vehicle 105 having a device 110. One or more persons 115 can be located on board the vehicle 105. In addition, one or more mobile devices 120 are located in an interior of the vehicle 105. Five mobile devices 120 are shown by way of example in FIG. 1, which bear numeric designations from 1 to 5. Each mobile device 120 can be assigned to a person 115. Multiple mobile devices 120 can also be assigned to one person 115.

A first mobile device 120 is placed on a shelf of the vehicle 105 in the area of a driver 115. A second exemplary mobile device 120 is held by a front passenger 115 in the hand. A third exemplary mobile device 120 lies on an otherwise empty middle seat in a second row of seats of the vehicle 105. A fourth exemplary mobile device 120 can be located in a piece of luggage 125. The piece of luggage 125 can be accommodated in a baggage compartment of the vehicle 105. A fifth exemplary mobile device 120 is located in a glove compartment of the vehicle 105.

The device 110 comprises a processing unit 130 and a graphic output unit 135, which is shown by way of example as a display screen, which can be accommodated, for example, in a center console of the vehicle 105. The output unit 135 can be embodied as integrated with an input device, in particular in the form of a touchscreen.

Furthermore, the device 110 preferably additionally comprises a communication unit 140, which is configured to communicate with a mobile device 120. The communication preferably takes place wirelessly and can be handled by means of a communication standard such as Wi-Fi or Bluetooth.

In addition, an interior camera 142 is provided, which is configured to optically scan an interior of the vehicle 105. In addition, a wireless sensor 145 can be provided which is configured to communicate with an identification unit, which can be comprised by a mobile device 120 or can be carried by a user 115. A wireless technology can be used here, for example, NFC. In the illustrated embodiment, multiple wireless sensors 145 are shown at different positions of the vehicle 105. For reasons of illustration, connections between the sensors 145 and the processing unit 130 are not shown. The positions shown of the sensors 145 are to be viewed as examples.

The processing unit 130 can furthermore be connected to an interface 150, which is connected to a further component on board the vehicle 105. The further component can in particular relate to an acoustic or optical output unit 135.

The device 110 is configured to detect one or more mobile devices 120 on board the vehicle 105. For this purpose, the mobile devices 120 can be detected by means of one or more sensors, in particular the camera 142 and/or a wireless sensor 145. Graphic representations of the detected mobile devices 120 can then be displayed on the display device 135. The display preferably takes place with respect to a graphic representation of the vehicle 105. An assignment of a user 115 with respect to the displayed graphic representation can then be detected and a service which runs on the mobile device 120 can be provided using a function of the vehicle 105. The function can in particular comprise a component which is activatable by means of the interface 150.

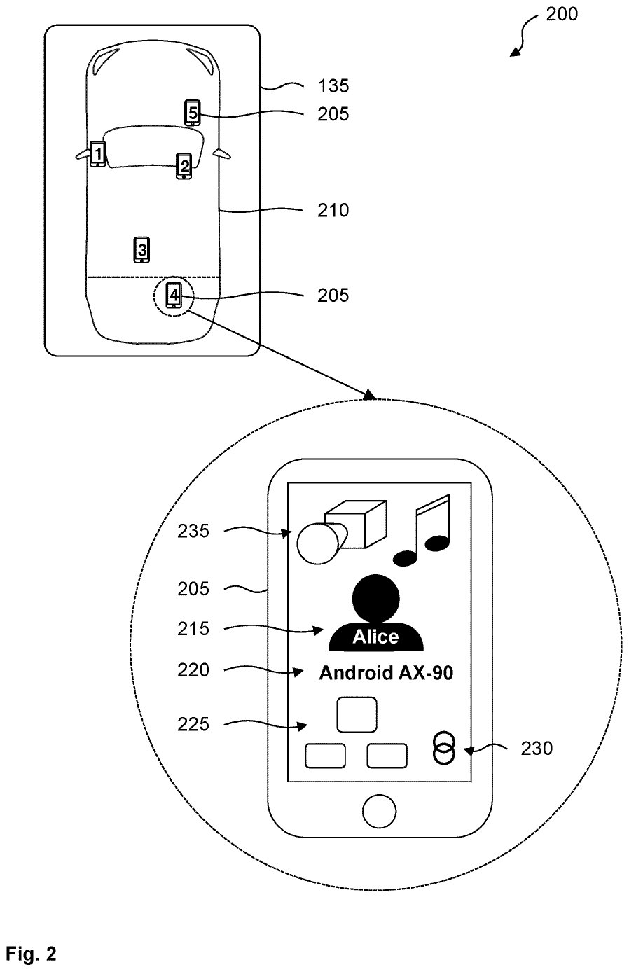

FIG. 2 shows an exemplary graphic representation 200. A display area of the output unit 135 is symbolically shown in the upper area of FIG. 2. Graphic representations 205 of the mobile devices 120 and preferably a graphic representation 210 of the vehicle 105 are displayed thereon. The displayed representations 205 of the mobile devices 120 bear exemplary identifications similar to those of the mobile devices 120 in the illustration of FIG. 1. Instead of these numeric identifications, other identifications can also be used. A graphic representation 205 of one of the mobile devices 120 is shown enlarged in a lower area of FIG. 2. The representation 205 itself can symbolize a device type or a producer of the mobile device 120 in shape, size, or appearance. Still further information, which is connected to the mobile device 120, can be displayed in the area of the representation 205. For example, a reference 215 of a user 115, to which the mobile device 120 is assigned, is shown in FIG. 2. For this purpose, a graphic, an image, a symbolic image, an avatar, or another graphic identifier can be displayed. In the present case, a username is additionally displayed.

Furthermore, a reference 220 to a model or an embodiment of the mobile device 120 is displayed. This information can also be provided in graphic form or textually as indicated in FIG. 2.

A reference 225 to a service which is executed or provided by the mobile device 120 can also be displayed.

In addition, a reference 230 to a coupling status with the vehicle 105 can be displayed. The coupling status can indicate whether data can be exchanged between the mobile device 120 and the vehicle 105 or in which phase a connecting method is located, which is configured to establish a communication connection between the mobile device 120 and the vehicle 105. Examples of phases which can be displayed comprise disconnected, detected, coupled, and connected.

A reference 235 to a vehicle resource which can be used by a service of the mobile device 120 can also be displayed. In the present case, a projector is shown as a symbol for an optical output and a music note is shown as a symbol of an acoustic output on the part of the vehicle 105 as examples.

It is to be noted that the representations 205, 210, and references 215 to 235 can also be displayed in another manner and other information can also be provided. The displayed information preferably makes a user 115 capable of establishing an assignment between a service and a vehicle resource. A communication connection required for this purpose can be automatically established or the establishment can be assisted when a corresponding assignment has been made.

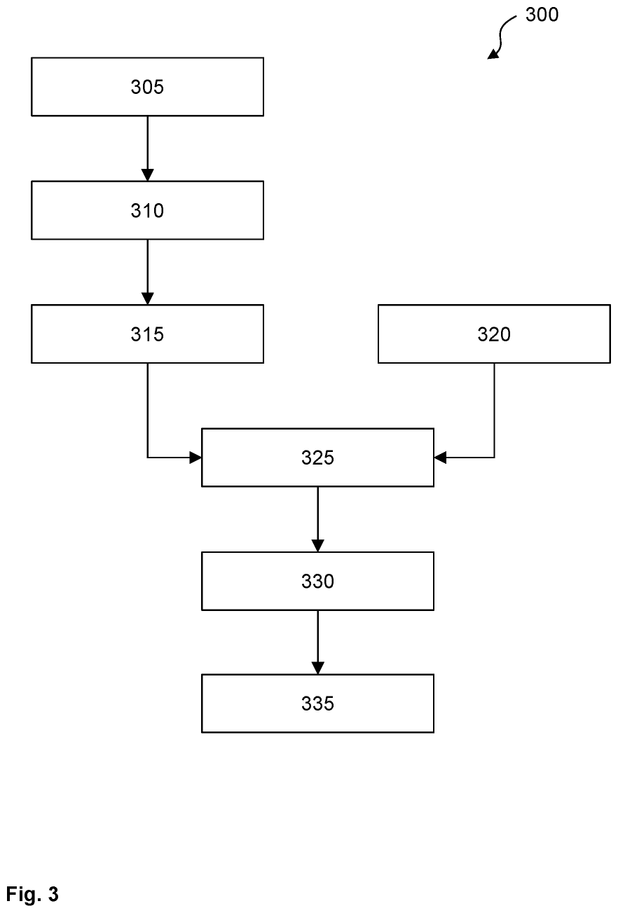

FIG. 3 shows a flow chart of a method 300. In a step 305, an interior of the vehicle 105 can be scanned. In particular, the sensors 142, 145 can be used for this purpose.

In a step 310, a mobile device 120 on board the vehicle 105 can be detected. In a step 315, information about the mobile device 120 can be collected. The information can require a communication with the mobile device 120 or can be acquired independently thereof. For example, a device, a model, or a producer can be determined on the basis of a visual detection. The mobile device 120 can also be assigned to a user 115 on board the vehicle 105. The user 115 can also be recognized by means of one of the sensors 142, 145. The information determined in the scope of a communication with the mobile device 120 can be configured by an assigned user 115. It can thus be ensured that a private sphere of the user 115 is preserved.

In a step 320, an infrastructure in the vehicle 105 can be determined. The infrastructure can relate in particular to resources or functions of the vehicle 105, the use of which by a service of a mobile device 120 can be possible. In this step, a configuration of the vehicle 105 can also be determined, on the basis of which the graphic representation 210 of the vehicle 105 is created. The configuration can comprise, for example, a presence of doors or seats.

In a step 325, the graphic representation 200 can be provided on an output unit 135. In a step 330, a user-controlled configuration can then be detected, which comprises an assignment of a service to a component of the infrastructure of the vehicle 105. This assignment can be checked for allowability to preclude, for example, multiple services from accessing the same resource in a competing manner. In addition, access rights can be checked, so that any arbitrary resource of the vehicle 105 cannot be assigned to each service.

In a step 335, the determined configuration can be controlled. For this purpose, in particular a data connection between a mobile device 120 and the vehicle 105 can be used to transmit input and/or output information of a service running on the mobile device 120 to the vehicle 105 or in the opposite direction. An input and/or output resource on board the vehicle 105 can in particular carry out an interaction with a user 115 on the basis of the transmitted data.

### LIST OF REFERENCE SIGNS

100 system
105 vehicle
110 device
115 person, user
120 mobile device
125 piece of luggage
130 processing unit
135 output unit, touchscreen
140 communication unit
142 camera, interior camera
145 wireless sensor
150 interface
200 graphic representation
205 graphic representation of a mobile device
210 graphic representation of the vehicle
215 reference to assigned user
220 reference to model of the mobile device
225 reference to service
230 reference to coupling status with the vehicle
235 reference to vehicle resource
300 method
305 scan interior
310 detect mobile device on board
315 collect information
320 determine infrastructure in the vehicle
325 display configuration graphic
330 detect configuration
335 control configuration

1.-13. (canceled)

14. A method for controlling a service on board a vehicle, the method comprising:
detecting a mobile device on board the vehicle;
providing a graphic representation of the mobile device; and
detecting an assignment of the detected mobile device to a function of the vehicle with respect to the graphic representation.

15. The method according to claim 14, wherein an identification of the mobile device is determined and the graphic representation comprises a reference to the identification.

16. The method according to claim 14, wherein a position of the mobile device on board the vehicle is determined and the graphic representation comprises a reference to the determined position.

17. The method according to claim 15, wherein a position of the mobile device on board the vehicle is determined and the graphic representation comprises a reference to the determined position.

18. The method according to claim 16, wherein the position of the mobile device with respect to the vehicle is graphically displayed.

19. The method according to claim 17, wherein the position of the mobile device with respect to the vehicle is graphically displayed.

20. The method according to claim 14, wherein a user assigned to the mobile device is determined and the representation comprises a reference to the determined user.

21. The method according to claim 15, wherein a user assigned to the mobile device is determined and the representation comprises a reference to the determined user.

22. The method according to claim 14, wherein the assignment comprises establishing a wireless pairing and/or connection of the mobile device to the vehicle.

23. The method according to claim 15, wherein the assignment comprises establishing a wireless pairing and/or connection of the mobile device to the vehicle.

24. The method according to claim 14, wherein the assignment comprises a determination of access rights.

25. An apparatus for controlling a service on board a vehicle, the apparatus comprising:
a sensor for detecting a mobile device on board the vehicle;
a graphic output unit for providing a graphic representation of the detected mobile device;
an input unit for detecting an assignment of the mobile device to a function of the vehicle with respect to the graphic representation; and
a control device for controlling the function in order to provide the service.

26. The apparatus according to claim 25, wherein the sensor comprises an interior camera.

27. The apparatus according to claim 25, wherein the sensor comprises a communication unit for wireless communication with the mobile device.

28. The apparatus according to claim 26, wherein the sensor comprises a communication unit for wireless communication with the mobile device.

29. The apparatus according to claim 25, wherein the output unit comprises a display screen on board the vehicle.

30. The apparatus according to claim 26, wherein the output unit comprises a display screen on board the vehicle.

31. The apparatus according to claim 27, wherein the output unit comprises a display screen on board the vehicle.

32. A vehicle comprising an apparatus according to claim 25, a wireless communication unit for communication with a mobile device, and at least one functional component for providing a service.

33. The vehicle according to claim 32, wherein the functional component comprises an optical, acoustic, or haptic input and/or output device for a person on board the vehicle.
